(19) United States
(12) Patent Application Publication
(10) Pub. No.: US 2022/0265100 A1
(43) Pub. Date: Aug. 25, 2022

(54) TOILET SCRUBBER

(71) Applicant: Bradshaw International, Inc., Rancho Cucamonga, CA (US)

(72) Inventor: Andre Sampaio, Valley Cottage, NY (US)

(73) Assignee: Bradshaw International, Inc., Rancho Cucamonga, CA (US)

(21) Appl. No.: 17/185,949

(22) Filed: Feb. 25, 2021

(51) Int. Cl. A47K 17/00; B08B 1/00

(52) U.S. Cl. CPC A47K 17/00; B08B 1/002

(57) ABSTRACT

A toilet scrubber and toilet scrubber caddy are disclosed where the toilet scrubber is formed as a modified elliptical hoop and made from a soft durometer material. The toilet scrubber is bristle-less, and relies on a series of protruding pins and blades for cleaning. The unique shape of the bristle-less toilet scrubber reduces the tendency for splashing of toilet water. The toilet scrubber is retained by a toilet scrubber caddy when not in use, where the caddy has an insert to retain water that drips from the toilet scrubber after use.

### BACKGROUND OF THE INVENTION

### 1. Field of the Invention

This invention relates generally to cleaning devices, and more specifically to a bristle-less toilet scrubber.

### 2. Description of Related Art

The need to clean a toilet has been around since the invention of the flushable toilet by Sir John Harington in 1596, if not before. While English inventor Alexander Cumming was granted the first patent for a flush toilet in 1775, it was not until the late 19^{th} century that a London plumber by the name of Thomas Crapper manufactured one of the first flush toilets. Toilets continue to evolve, but the need to clean them remains.

It is common for one to use a toilet brush to engage in the act of cleaning this sanitation device. A toilet brush ordinarily has bristles protruding from a head, often made of a wire frame and configured in a U-shape with an attached handle to keep the user's hands dry and above the water line. While these toilet brushes work, they often lack the cleaning power needed to remove stubborn or caked on deposits. Furthermore, over time the bristles lose their shape, break, or fall out.

Due to the shape of most toilet brushes (a bristle head with a shaft handle attached), they do not stand upright without some form of holder. These holders often allow the used toilet brush to drip toilet water on the floor, or otherwise create an unhygienic situation.

In addition, most toilet brushes do not have a hydrodynamic profile, and tend to splash toilet water, a tendency not well received by most users.

What is therefore needed is a toilet scrubber that provides improved cleaning ability over a standard bristled toilet brush. What is also needed is a toilet scrubber that does not splash water while in use. What is further needed is a toilet scrubber with a holder that has an insert to prevent toilet water from dripping on the floor after use.

It is thus an object of the present invention to provide such a toilet scrubber.

These and other objects of the present invention are not to be considered comprehensive or exhaustive, but rather, exemplary of objects that may be ascertained after reading this specification and claims with the accompanying drawings.

### BRIEF SUMMARY OF THE INVENTION

In accordance with the present invention, there is provided a toilet scrubber comprising a scrubber head formed as a modified elliptical hoop having an interior surface, an exterior surface, a first side, a second side, a top and a bottom; the exterior surface of the modified elliptical hoop comprising an array of alternating blades and pins protruding from the exterior surface; the scrubber head made from a soft durometer material; a scrubber shaft operatively connected to the scrubber head; a scrubber handle attached to the scrubber shaft; and a top shield located between the scrubber shaft and the scrubber handle. In some embodiments of the present invention, a toilet scrubber caddy is included where the toilet scrubber caddy comprises a caddy, a removable base attached to the caddy, and a caddy insert removably attached to the removable base and contained within the caddy.

The foregoing paragraph has been provided by way of introduction, and is not intended to limit the scope of the invention as described in this specification, claims and the attached drawings.

### BRIEF DESCRIPTION OF THE DRAWINGS

The invention will be described by reference to the following drawings, in which like numerals refer to like elements, and in which:

FIG. 1 is a perspective view of a toilet scrubber and caddy of the present invention;

FIG. 2 is a side plan view of the toilet scrubber and caddy of FIG. 1;

FIG. 3 is an alternate side plan view of the toilet scrubber and caddy of FIG. 1;

FIG. 4 is a rotated side plan view of the toilet scrubber and caddy of FIG. 1;

FIG. 5 is an alternate rotated side plan view of the toilet scrubber and caddy of FIG. 1;

FIG. 6 is a top plan view of the toilet scrubber and caddy of FIG. 1;

FIG. 7 is a bottom plan view of the toilet scrubber and caddy of FIG. 1;

FIG. 8 is a separated perspective view of the toilet scrubber and caddy;

FIG. 9 is an exploded and disassembled view of the toilet scrubber and caddy of FIG. 1;

FIG. 10 is a perspective view of the toilet scrubber;

FIG. 11 is a side plan view of the toilet scrubber;

FIG. 12 is an alternate side plan view of the toilet scrubber;

FIG. 13 is a rotated side plan view of the toilet scrubber;

FIG. 14 is an alternate rotated side plan view of the toilet scrubber; and

FIG. 15 is a bottom plan view of the toilet scrubber.

The attached figures depict various views of the toilet scrubber and caddy in sufficient detail to allow one skilled in the art to make and use the present invention. These figures are exemplary, and depict a preferred embodiment; however, it will be understood that there is no intent to limit the invention to the embodiment depicted herein. On the contrary, the intent is to cover all alternatives, modifications, and equivalents as may be included within the spirit and scope of the invention as defined by this specification, claims and drawings.

### DESCRIPTION OF THE PREFERRED EMBODIMENTS

A Toilet Scrubber and related Caddy are described and depicted by way of this specification and the attached drawings.

For a general understanding of the present invention, reference is made to the drawings. In the drawings, like reference numerals have been used throughout to designate identical elements.

The Toilet Scrubber of the present invention, as described and depicted herein, provides, among other things, a novel scrubber head that is more effective at cleaning than bristle based toilet brushes, and also reduces the tendency to create splashes in use, providing for a more effective and hygienic cleaning device. The toilet scrubber of the present invention also may incorporate a novel caddy arrangement for retention and storage of the toilet scrubber.

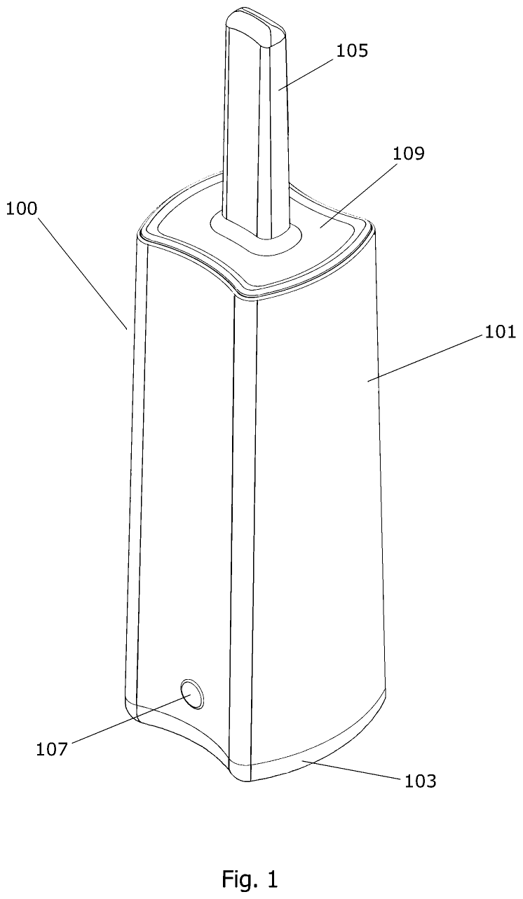

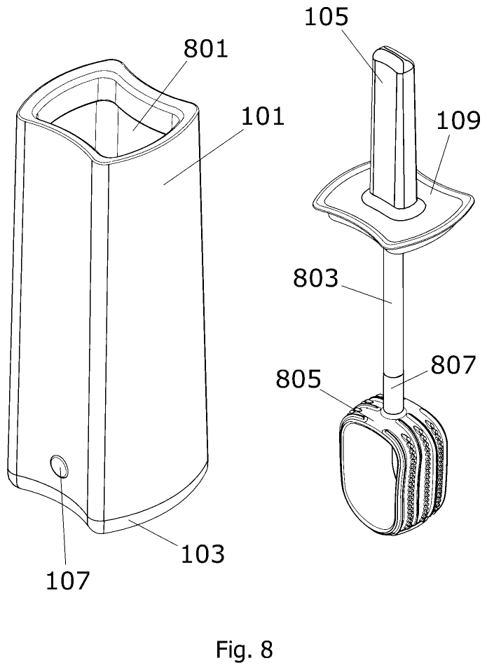

FIG. 1 is a perspective view of a toilet scrubber and caddy of the present invention. The toilet scrubber and caddy may be made from any suitable material, for example, a plastic. Examples of suitable plastics include acrylonitrile butadiene styrene (ABS), polyethylene, polypropylene, polystyrene, polyvinyl chloride, polytetrafluoroethylene, and the like. Bioplastics may also be used in some embodiments of the present invention. In addition, reinforced plastics, metals, wood, or other materials that may be suitably formed may also be used. The various components of the toilet scrubber and caddy may be made by injection molding, blow molding, machining, extruding, forming, or the like. The various components are then assembled in accordance with the instructions and figures provided herein. The scrubber head (not seen in FIG. 1, see FIG. 8, 805) is made from a soft or semi-soft durometer material such as a thermoplastic elastomer (TPE) and joined to the scrubber shaft and related scrubber handle and top shield.

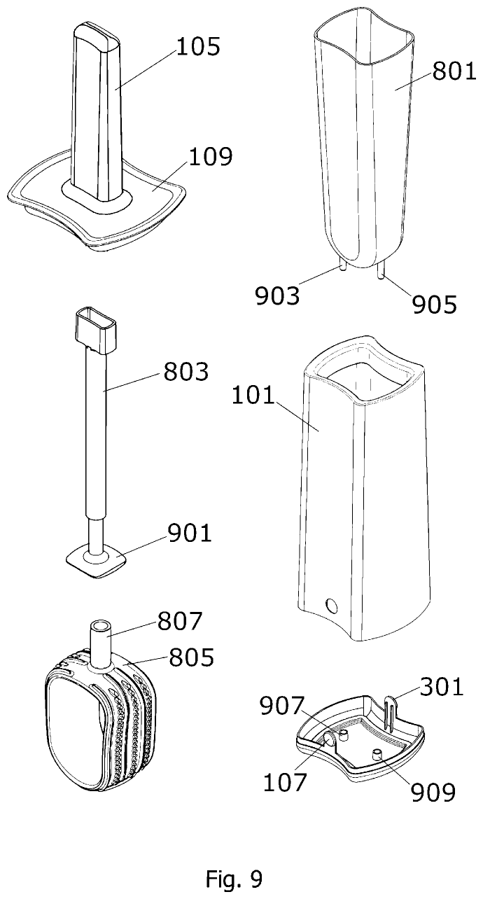

FIGS. 1-7 depict the caddy and toilet scrubber in an assembled and stored state where the toilet scrubber is retained by the caddy and ready for use. As will be described and depicted herein, the caddy has a removable caddy insert that retains any dripping water from the toilet scrubber after use, and a removable base that facilitates removal of the caddy insert. FIG. 1 is a perspective view of a toilet scrubber and caddy 100 of the present invention showing the toilet scrubber 100 retained by the caddy 101. The caddy 101 may, in some embodiments, have two concave and two convex sides to not only provide an aesthetically pleasing look, but also to allow for positive engagement and retention of a caddy insert (see FIG. 9) and the top shield 109 of the toilet scrubber. This shape also makes it easy to pick up and move the caddy. The caddy 101 may have at least one live hinge opening that retains a first live hinge button 107 and in some embodiments a second live hinge button 301, each or both of which are attached to a removable base 103 for retention thereof (see FIG. 9). The removable base 103 engages with the body of the caddy 101 and also has fixturing to removably attach a caddy insert (again see FIG. 9). As seen in FIG. 1, a handle 105 has a top shield 109 and is retained by the top portion of the caddy 101. The handle 105 and top shield 109 are further attached to a shaft and scrubber head to make up the toilet scrubber, as will be further described herein.

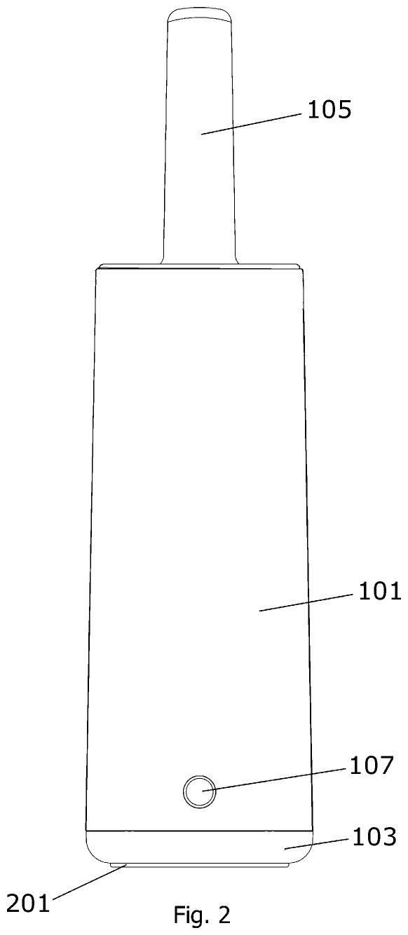

FIG. 2 is a side plan view of the toilet scrubber and caddy of FIG. 1. The first live hinge button 107 of the removable base 103 can be seen engaged with a hole or similar opening in the caddy 101. In addition, a base offset 201 can be seen that raises the caddy slightly to prevent sliding and to eliminate the tendency for moisture to accumulate under the caddy.

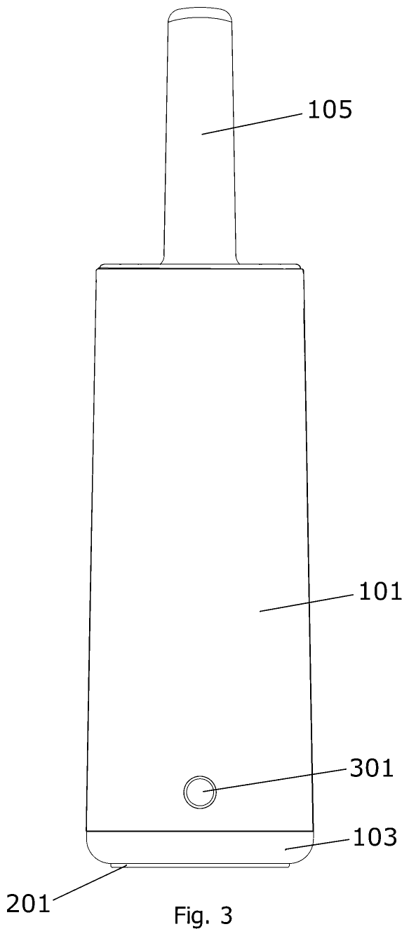

FIG. 3 is an alternate side plan view of the toilet scrubber and caddy of FIG. 1 where a second live hinge button 301 can be seen. The second live hinge button, similar to the first live hinge button 107 shown in FIGS. 1 and 2, is hingeably affixed to the removable base 103, and in turn engaged with a hole or similar opening in the caddy 101.

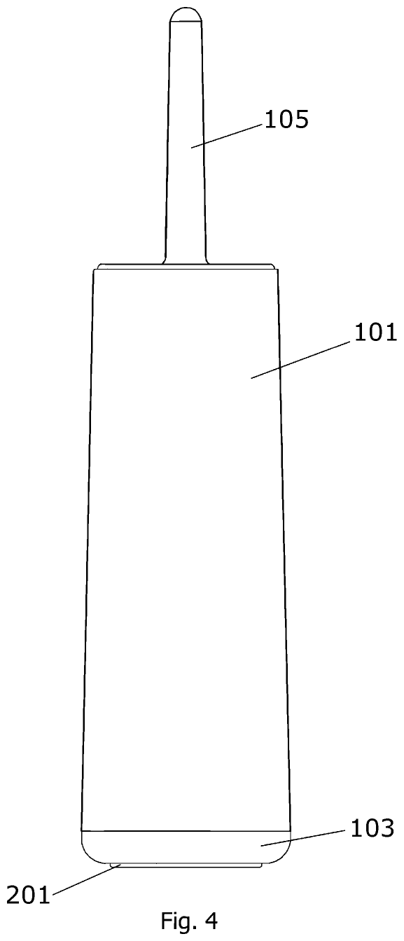

FIG. 4 is a rotated side plan view of the toilet scrubber and caddy of FIG. 1 that also shows the removable base 103 engaged with the caddy 101 and the handle 105 and related top shield retained by the caddy 101. The base offset 201 can also be seen.

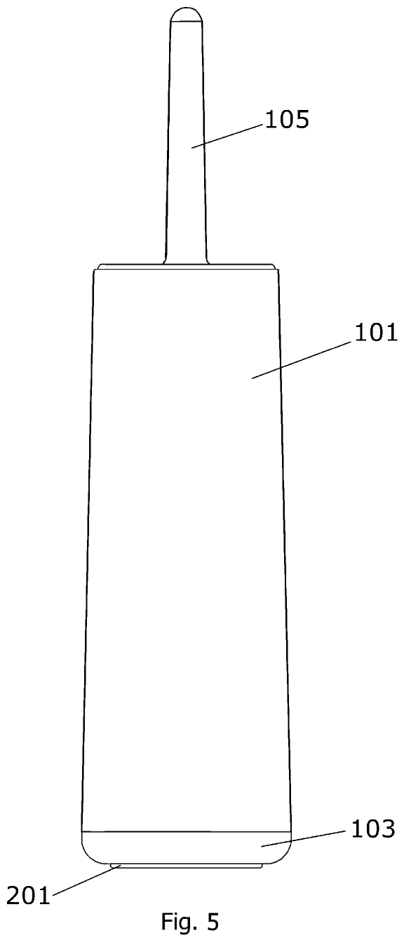

FIG. 5 is an alternate rotated side plan view of the toilet scrubber and caddy of FIG. 1 where the removable base 103 can again be seen engaged with the caddy 101. The handle 105 and related top shield can be seen retained by the caddy 101. The base offset 201 can also be seen.

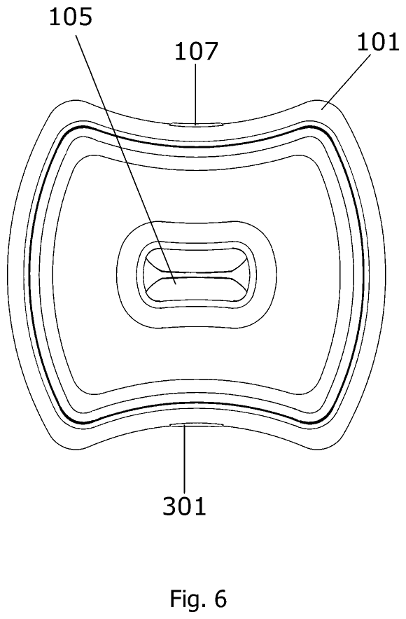

FIG. 6 is a top plan view of the toilet scrubber and caddy of FIG. 1. The top of the scrubber handle 105 can be seen where the shape of the scrubber handle 105 may, in some embodiments of the present invention, be of a shape similar to that of the caddy 101. The top shield 109 may also, in some embodiments of the present invention, be of a shape similar to that of the caddy 101.

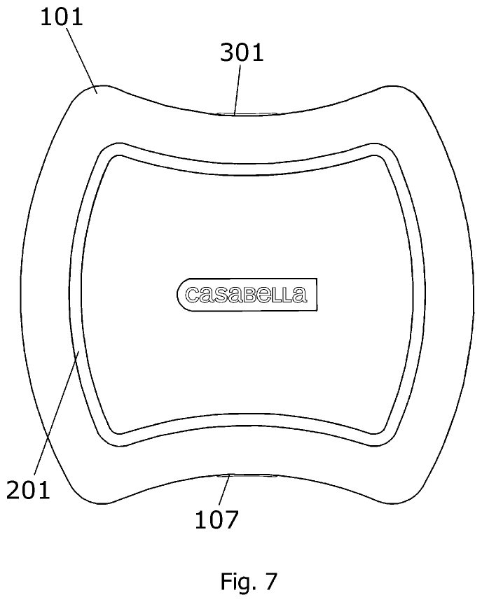

FIG. 7 is a bottom plan view of the toilet scrubber and caddy of FIG. 1 showing clearly the shape of the base offset 201. The first live hinge button 107 and the second live hinge button 301 can also be seen slightly protruding from the perimeter of the base offset 201.

For a full appreciation of the interoperability between the toilet scrubber and the caddy, FIG. 8 is a separated perspective view of the toilet scrubber and caddy. The caddy 101 can be seen with the caddy insert 801 clearly visible. The caddy insert 801 is removable for cleaning and the like, and prevents water from dripping from the toilet scrubber onto the floor. The caddy insert 801, in some embodiments, is smaller than the caddy 101 in both width and length to facilitate placement and retention of the caddy insert 801 within the caddy 101. To the right of the caddy 101 the toilet scrubber can be seen. The scrubber head 805 is formed as a modified elliptical hoop and has an interior surface, an exterior surface, a first side, a second side, a top and a bottom. The modified elliptical hoop geometry is essentially a flat portion formed into a hoop. The hoop may, in some embodiments, be formed as a modified elliptical hoop where the modified ellipse may, in some embodiments, be of a shape where the ellipse is rounded at the bottom of the scrubber head 805 and squared off at the top of the scrubber head 805. In some embodiments, the hoop may have a slightly convex appearance where the exterior surface is slightly convex and the interior surface is slightly concave. A scrubber shaft 803 can be seen attached to the scrubber head 805 with a scrubber head connector 807. The scrubber head connector 807 may, in some embodiments of the present invention, be formed with the scrubber head 805 and made from the same material as the scrubber head 805. The top shield 109 is formed with or otherwise attached to the scrubber shaft 803 and the scrubber handle 105.

FIG. 9 is an exploded and disassembled view of the toilet scrubber and caddy of FIG. 1 that shows the toilet scrubber components in a disassembled state. It should be noted that while FIG. 9 shows specific components that are used during assembly, other components, assembly techniques, sizes and geometries may also be employed that also result in a toilet scrubber of the present invention. The scrubber head 805 and scrubber head connector 807 can be seen in FIG. 9 with the scrubber shaft 803 and shaft connector 901 above it. The shaft connector 901 is shown as a generally flat plate that is molded into or otherwise attached to the scrubber head 805. The scrubber head connector 807 in turn surrounds and couples with the scrubber shaft 803, specifically the smaller diameter portion of the scrubber shaft 803. At the end of the scrubber shaft opposite the smaller diameter portion, a rectangular coupler can be seen that engages with the top shield 109, and may, in some embodiments of the present invention, be permanently attached to the top shield 109 with an adhesive or co-molding thereof.

Turning to the right side of FIG. 9, an exploded view of the caddy 101 can also be seen. The caddy insert 801 can be seen with a first pin 903 and a second pin 905 protruding from the bottom of the caddy insert 801. The caddy insert 801, in some embodiments of the present invention, is placed within the caddy 101 through the bottom of the caddy 101. The caddy insert 801 is then retained in the caddy 101 by a removable base 103 that has a first pin receiver 907 and a second pin receiver 909. The pin receivers are cylindrical and hollow, and the pins of the caddy insert 801 are inserted therein. The first live hinge button 107 and the second live hinge button 301 can be seen attached to the removable base 103. The removable base thus acts to retain the caddy insert 801 and provide overall support of the caddy 101.

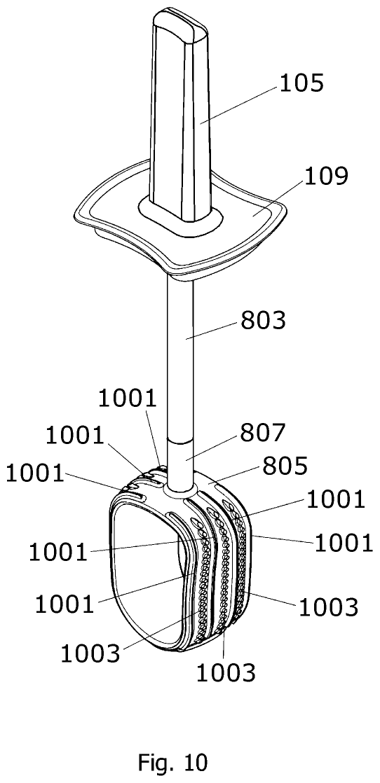

Further detail of the toilet scrubber is provided by way of FIG. 10, which is a perspective view of the toilet scrubber. In FIG. 10, the scrubber shaft 803 can be seen connected to the scrubber head 805 by way of the scrubber head connector 807. The exterior surface of the scrubber head 805 can be seen having an array of alternating blades 1001 and pins 1003. The blades and pins protrude from the exterior surface to provide cleaning. The blades 1001 function similar to small squeegees and the pins 1003 function as scrubbers. The pins 1003 break up dirt on the surface of the toilet bowl and the blades 1001 scrape and push the dirt to the water. Further, the shape of the scrubber head as a hoop or loop allows water to pass through it without splashing it around. In one embodiment, the pins 1003 are arranged in rows wherein each row of pins 1003 is separated by a blade 1001.

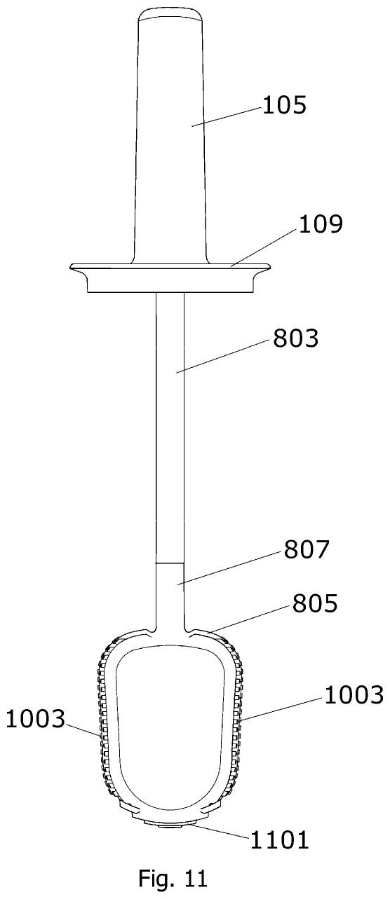

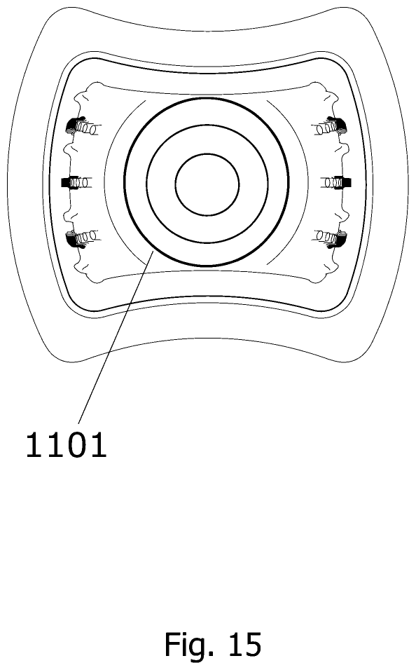

FIG. 11 is a side plan view of the toilet scrubber clearly showing the shape of the scrubber head 805. Also seen in FIG. 11 are protruding concentric blades 1101 at the bottom of the scrubber head 805 that will be clearly seen and described in FIG. 15.

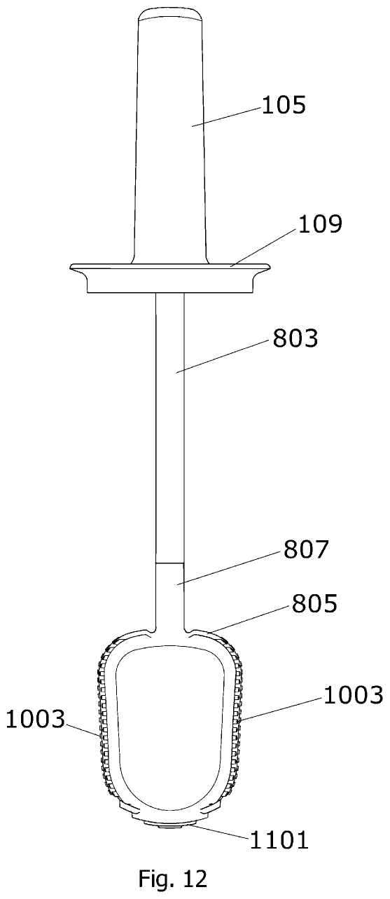

FIG. 12 is an alternate side plan view of the toilet scrubber which is similar to the first side plan view of the toilet scrubber shown in FIG. 11.

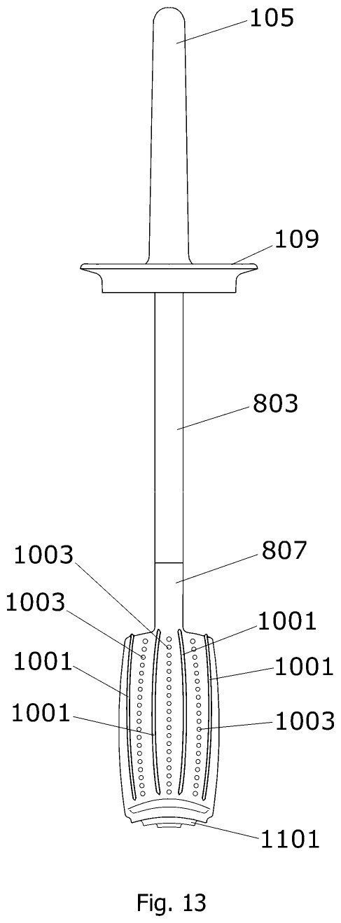

Turning now to FIG. 13, a rotated side plan view of the toilet scrubber can be seen where the blades 1001 and pins 1003 can be seen. The pins 1003 may be conical, rounded, truncated, flat, or of a protrusion sufficient to scrub and remove dirt and grime from a toilet bowl. The blades 1001 between the rows of pins 1003 preferably protrude from the scrubber head at a distance roughly equal to the protrusion height of the pins, allowing both blades 1001 and pins 1003 to contact and clean the toilet bowl.

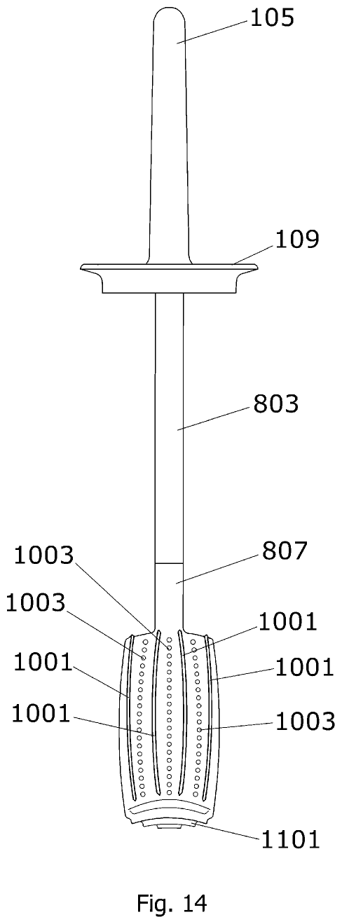

FIG. 14 is an alternate rotated side plan view of the toilet scrubber which is similar to the side depicted in FIG. 13.

Lastly, FIG. 15 is a bottom plan view of the toilet scrubber showing the bottom of the scrubber head 805 of the toilet scrubber where the concentric blades 1101 can be clearly seen. The concentric blades 1101 provide additional cleaning surfaces and act in a manner similar to the blades 1001. While the bottom of the toilet scrubber may comprise concentric blades 1101, other blade configurations may be employed that include, but are not limited to, elliptical, straight, curved, square, rectangular, hexagonal, octagonal, and the like.

To use the toilet scrubber, one grasps the scrubber handle 105, inserts the scrubber head 805 into a toilet to be cleaned, and moves the scrubber head 805 along and around the toilet bowl surface in a manner sufficient to clean the toilet bowl and related areas. Once the toilet has been cleaned, the toilet scrubber is moved through the water to clean the scrubber head 805 of any adhering debris, and placed into the caddy 101 for storage.

It is, therefore, apparent that there has been provided, in accordance with the various objects of the present invention, a toilet scrubber and caddy. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, claims and the attached drawings.

What is claimed is:

1. A toilet scrubber comprising:
a scrubber head formed as a modified elliptical hoop having an interior surface, an exterior surface, a first side, a second side, a top and a bottom;
the exterior surface of the modified elliptical hoop comprising an array of alternating blades and pins protruding from the exterior surface;
the scrubber head made from a soft durometer material;
a scrubber shaft operatively connected to the scrubber head; and
a scrubber handle attached to the scrubber shaft.

2. The toilet scrubber of claim 1, wherein the modified elliptical hoop is rounded at the bottom and squared off at the top.

3. The toilet scrubber of claim 1, wherein the bottom of the scrubber head comprises a series of concentric circular blades.

4. The toilet scrubber of claim 1, wherein the pins are arranged in rows wherein each row of pins is separated by a blade.

5. The toilet scrubber of claim 1, further comprising a top shield located between the scrubber shaft and the scrubber handle.

6. The toilet scrubber of claim 5, wherein the top shield is configured to engage with a toilet scrubber caddy.

7. The toilet scrubber of claim 5, wherein the top shield and the scrubber handle are formed as a single piece.

8. A toilet scrubber and toilet scrubber caddy comprising:
a toilet scrubber comprising a scrubber head formed as a modified elliptical hoop having an interior surface, an exterior surface, a first side, a second side, a top and a bottom;
the exterior surface of the modified elliptical hoop comprising an array of alternating blades and pins protruding from the exterior surface;
the scrubber head made from a soft durometer material;
a scrubber shaft operatively connected to the scrubber head;
a scrubber handle attached to the scrubber shaft; and
a top shield located between the scrubber shaft and the scrubber handle;
a toilet scrubber caddy comprising a caddy, a removable base attached to the caddy, and a caddy insert removably attached to the removable base and contained within the caddy.

9. The toilet scrubber and toilet scrubber caddy of claim 8, wherein the top shield of the toilet scrubber is configured to engage with the toilet scrubber caddy.

10. The toilet scrubber and toilet scrubber caddy of claim 8, wherein the caddy insert of the toilet scrubber caddy comprises a first live hinge button and a second live hinge button to releasably engage with holes in the caddy.

11. The toilet scrubber and toilet scrubber caddy of claim 8, wherein the removable base of the toilet scrubber caddy comprises a first pin receiver and a second pin receiver.

12. The toilet scrubber and toilet scrubber caddy of claim 11, wherein the caddy insert of the toilet scrubber caddy comprises a first pin and a second pin to releasably engage with the first pin receiver and the second pin receiver of the removable base.

13. The toilet scrubber and toilet scrubber caddy of claim 8, wherein the removable base of the toilet scrubber caddy comprises a base offset.

14. The toilet scrubber and toilet scrubber caddy of claim 8, wherein the bottom of the scrubber head of the toilet scrubber comprises a series of concentric circular blades.

15. The toilet scrubber and toilet scrubber caddy of claim 8, wherein the pins of the toilet scrubber are arranged in rows wherein each row of pins is separated by a blade.

16. The toilet scrubber and toilet scrubber caddy of claim 8, wherein the modified elliptical hoop of the scrubber head is rounded at the bottom and squared off at the top.

17. A toilet scrubber head comprising:
a soft durometer material formed as a modified elliptical hoop;
an interior surface, an exterior surface, a first side, a second side, a top and a bottom;
the exterior surface of the modified elliptical hoop comprising an array of alternating blades and pins protruding from the exterior surface; and
a scrubber head connector protruding from the top of the toilet scrubber head.

18. The toilet scrubber head of claim 17, wherein the modified elliptical hoop is rounded at the bottom and squared off at the top.

19. The toilet scrubber head of claim 17, wherein the bottom of the toilet scrubber head comprises a series of concentric circular blades.

20. The toilet scrubber head of claim 17, wherein the pins are arranged in rows wherein each row of pins is separated by a blade.
